(19) United States
(12) Patent Application Publication
(10) Pub. No.: US 2024/0054336 A1
(43) Pub. Date: Feb. 15, 2024

(54) MODEL SCALING FOR MULTIPLE ENVIRONMENTS USING MINIMUM SYSTEM INTEGRATION

(71) Applicant: Hitachi, Ltd., Chiyoda-ku (JP)

(72) Inventors: Ravneet KAUR, San Jose, CA (US); Andrew Walker, Santa Clara, CA (US); Joydeep Acharya, Milpitas, CA (US)

(21) Appl. No.: 17/888,268

(22) Filed: Aug. 15, 2022

(51) Int. Cl. G06N 3/08

(52) U.S. Cl. CPC G06N 3/08

(57) ABSTRACT

In example implementations described herein, there are systems and methods for generating at least a first set of weights for a first neural network associated with a first task performed in a first environment and a second set of weights for a second neural network associated with the first task performed in a second environment; training a metamodel based on at least the first set of weights and the second set of weights; and generating, based on the metamodel, a third set of weights for a third neural network associated with a second task in the second environment.

### BACKGROUND

### Field

The present disclosure is generally directed to machine learning for manufacturing processes.

### Related Art

In factories, analytics solutions are usually custom developed for one line and/or product and much system integration is needed to modify the solution for application to another line and/or product due to a change in deployment conditions such as lighting, camera placement, line condition, etc. This individualized system integration increases the deployment cost and time. Furthermore, there are times when data drift may occur which results in decreased model performance due to a change in the model input. Data drift is caused either by natural phenomenon such as change in environmental conditions or the change in the sensor parameters. Monitoring and compensating this data drift may detect and resolve the degradation in model performance.

In existing technologies, meta learning has been used where multipart artificial neural networks (ANN) including a main ANN and an auxiliary ANN used to solve a specific problem in a specific environment. Here unlabeled data may be received from a source and trained in the auxiliary ANN in an unsupervised mode. This unsupervised training may learn the underlying structure by training multiple auxiliary tasks to generate labeled data from the unlabeled data. The weights generated by this auxiliary training may be frozen and transferred to the main ANN. Then the main ANN may use the weights to generate labeled data which are then used to train the main task using these labeled questions and the original question to be answered is then applied to this trained main ANN which can then assign one of the defined categories. In this technology, the output from one trained model is being used to train another model in order to learn the underlying structure and thus assigning the classification task.

When developing an analytics solution for a task/product in a first environment in a factory, the developed solution is customized for that environment. Thus, utilizing that solution for the same task/product in a different environment may be difficult to accomplish due to deployment conditions of the new environment (such as environmental conditions, camera placement, or production line conditions).

Naively, a same set of models developed for a first environment can be reused for tasks in a second environment. However, if the deployment conditions (such as background, camera angle, lighting conditions, etc.) in the second environment are too far off from the first environment, these models will be inaccurate in the new environment.

Alternatively, new models can be developed for the second environment in the same way as for the first environment. Training new models in this manner may be expensive as it requires annotating a high volume of data which will turn out to be time consuming and costly. Thus, a solution that can take a set of models from a first environment and derive models for a second environment may reduce the expense and effort to derive models for the second environment.

### SUMMARY

Example implementations described herein involve an innovative method to generate models for a set of tasks in a second environment based on a set of models generated for a corresponding set of tasks in a first environment.

Aspects of the present disclosure include a method which can involve generating at least a first set of weights for a first neural network associated with a first task performed in a first environment and a second set of weights for a second neural network associated with the first task performed in a second environment; training a metamodel based on at least the first set of weights and the second set of weights; and generating, based on the metamodel, a third set of weights for a third neural network associated with a second task in the second environment.

Aspects of the present disclosure include a non-transitory computer readable medium, storing instructions for execution by a processor, which can involve instructions for generating at least a first set of weights for a first neural network associated with a first task performed in a first environment and a second set of weights for a second neural network associated with the first task performed in a second environment; training a metamodel based on at least the first set of weights and the second set of weights; and generating, based on the metamodel, a third set of weights for a third neural network associated with a second task in the second environment.

Aspects of the present disclosure include a system, which can involve means for generating at least a first set of weights for a first neural network associated with a first task performed in a first environment and a second set of weights for a second neural network associated with the first task performed in a second environment; training a metamodel based on at least the first set of weights and the second set of weights; and generating, based on the metamodel, a third set of weights for a third neural network associated with a second task in the second environment.

Aspects of the present disclosure include an apparatus, which can involve a processor, configured to generate at least a first set of weights for a first neural network associated with a first task performed in a first environment and a second set of weights for a second neural network associated with the first task performed in a second environment; train a metamodel based on at least the first set of weights and the second set of weights; and generate, based on the metamodel, a third set of weights for a third neural network associated with a second task in the second environment.

### BRIEF DESCRIPTION OF DRAWINGS

FIG. 1 is a diagram illustrating a set of multiple environments where a first set of tasks is performed in each of the environments.

FIG. 2 is a diagram illustrating a set of two environments in which a same set of tasks is performed.

FIG. 3 is a diagram illustrating an example of a generation of a neural network and a related set of weights based on an input dataset and a set of labels.

FIG. 4 is a diagram illustrates a set of two environments for which the method may be applied.

FIG. 5 is a diagram illustrates a set of two environments for which the method may be applied.

FIG. 6 is a diagram of an overview of the process of using a meta learning based model to generate a set of weights for unlabeled datasets in a second environment from a set of labeled datasets (and associated weights) in a first environment.

FIG. 7 is a diagram illustrating the metamodel generation in accordance with some aspects of the disclosure.

FIG. 8 is a diagram illustrating a feedback process for training the neural network.

FIG. 9 is a flow diagram illustrating a method in accordance with some aspects of the disclosure.

FIG. 10 is a flow diagram illustrating a method in accordance with some aspects of the disclosure.

FIG. 11 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve an innovative method to generate models for a set of tasks in a second environment based on a set of models generated for a corresponding set of tasks in a first environment. Aspects of the present disclosure include a method which can involve generating at least a first set of weights for a first neural network associated with a first task performed in a first environment and a second set of weights for a second neural network associated with the first task performed in a second environment; training a metamodel based on at least the first set of weights and the second set of weights; and generating, based on the metamodel, a third set of weights for a third neural network associated with a second task in the second environment.

In some aspects, the method involves meta learning. Meta learning as used herein refers to a machine learning algorithm that learns from the output of other machine learning algorithms. Generally, for a meta learning algorithm, a 1^{st} base model is built and/or trained, and results are predicted and compared with the ground truth, and high accuracy predicted results are then filtered using a threshold. A 2^{nd} model may then be built and/or trained using the prediction from the 1^{st} base model as input to the 2^{nd} model and another set of predictions are made. This process of using predictions from a 1^{st} model as an input to the 2^{nd} model may generally be referred to as meta learning. In this disclosure, instead of using the model output from the 1^{st} model (e.g., predictions) as input to the 2^{nd} model, weights from the 1^{st} model may be used as input to another model to generate weights for the 2^{nd} model.

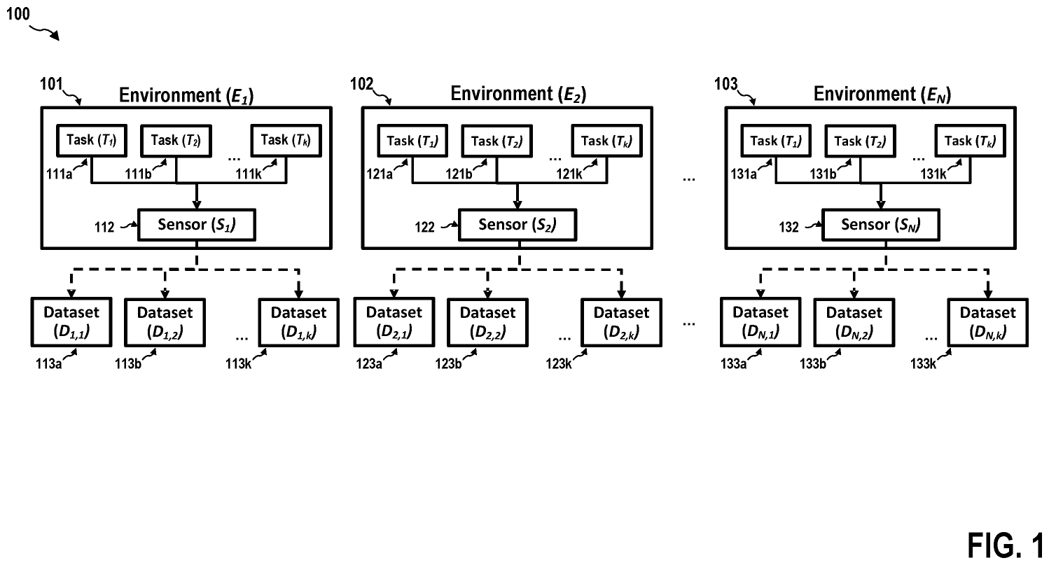

FIG. 1 is a diagram 100 illustrating a set of multiple environments (e.g., multiple factories or multiple production lines in a same factory) where a first set of tasks (e.g., a set of ‘K’ tasks) is performed in each of the environments. Diagram 100 illustrates multiple environments, environment 101 (E₁), environment 102 (E₂), and environment 103 (E_{N}). Each environment is associated with a set of tasks (e.g., a first task (T₁) 111a in environment 101 (E₁), a first task (T₁) 121a in environment 102 (E₂), and a first task (T₁) 131a in environment 103 (E_{N}); a second task (T₂) 111b in environment 101 (E₁), a second task (T₂) 121b in environment 102 (E₂), and a second task (T₂) 131b in environment 103 (E_{N}); through a K^{th} task (Tₖ) 111k in environment 101 (E₁), a K^{th} task (Tₖ) 121k in environment 102 (E₂) 121k, and a K^{th} task (Tₖ) 131k in environment 103 (E_{N})). In each environment, there may be a set of sensors (e.g., sensors (S₁) 112, sensors (S₂) 122, and sensors (Sₖ) 132 in environments 101 (E₁), 102 (E₂), and 103 (E_{N}), respectively) associated with the set of tasks (e.g., 111a-111k, 121a-121k, and 131a-131k). The sensors 112, 122, and 132, in some aspects, may collect image data, vibration data, acoustic data, distance/ranging data, temperature, or other relevant data. The set of sensors in each environment may produce a dataset associated with (e.g., used as input for predictions regarding) each task. The datasets for the first environment 101 (E₁) may include dataset (D_{1,1}) 113a, dataset (D_{1,2}) 113b, and dataset (D_{1,k}) 113k; the datasets for the second environment 102 (E₂) may include dataset (D_{2,1}) 123a, dataset (D_{2,2}) 123b, and dataset (D_{2,k}) 123k; the datasets for the third environment 103 (Eₖ) may include dataset (D_{N,1}) 133a, dataset (D_{N,2}) 133b, and dataset (D_{N,k}) 133k.

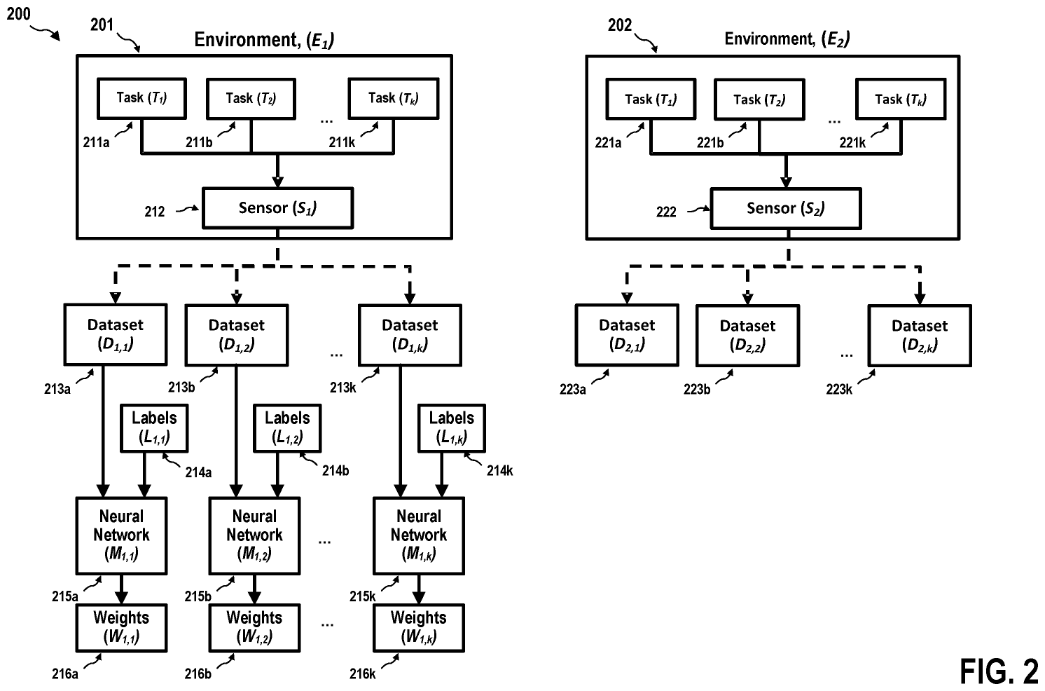

FIG. 2 is a diagram 200 illustrating a set of two environments (e.g., environment 201 (E₁) and environment 202 (E₂)) in which a same set of tasks (e.g., tasks T₁ to Tₖ) is performed. While the tasks being performed in the two environments (e.g., environments 201 and 202) may be the same, but the sensors (e.g., sensors 212 and/or 222) used, or the deployment conditions of the sensors, may not be the same in the two environments. Accordingly, datasets for the two environments (e.g., a dataset 213a (D_{1,i}) and a dataset 223a (D_{2,1}), or datasets 213b/223b, and/or 213k/223k) may be different. The different datasets, in some aspects, may be correlated or related based on the nature of the underlying tasks. For example, a first camera in a first environment may capture a product traversing (or associated with) a first task (stage) of a production line in a first direction while a second camera in the second environment may capture the product traversing (or associated with) the first task (stage) of a production line in a second direction based on a different camera placement such that the images are correlated (e.g., horizontally and/or vertically flipped) but different.

For the datasets including dataset (D_{1,1}) 213a, dataset (D_{1,2}) 213b, and dataset (D_{1,k}) 213k in the first environment 201 may be manually labeled by a user with labels (L_{1,1}) 214a, labels (L_{1,2}) 214b, and labels (L_{1,k}) 214k, respectively. The datasets (e.g., datasets 213a, 213b, and/or 213k) and the labels (e.g., labels 214a, 214b, and/or 214k) may be used to train a set of neural networks including neural network (M_{1,1}) 215a, neural network (M_{1,2}) 215b, and/or neural network (M_{1,k}) 215k, respectively. Training the neural networks, in some aspects, results in a set of weights associated with each of the neural networks, e.g., weights (W_{1,1}) 216a, weights (W_{1,2}) 216b, and/or weights (W_{1,k}) 216k. While diagram 200 illustrates that the datasets 213a, 213b, and 213k associated with the tasks 211a, 211b, and 211k may be associated with labels 214a, 214b, and 214k used to train the neural networks 215a, 215b, and 215k (e.g., to generate the set of weights 216a, 216b, and 216k), the datasets 223a, 223b, and 223k associated with the tasks 221a, 221b, and 221k may not be labeled and neural networks may not be trained (e.g., weights may not be generated for a set of neural networks). In some aspects, the disclosure relates to finding weights for a set of neural networks corresponding to the tasks 221a, 221b, and 221k without having to generate labels for the datasets 223a, 223b, and 223k collected relating to the tasks 221a, 221b, and 221k.

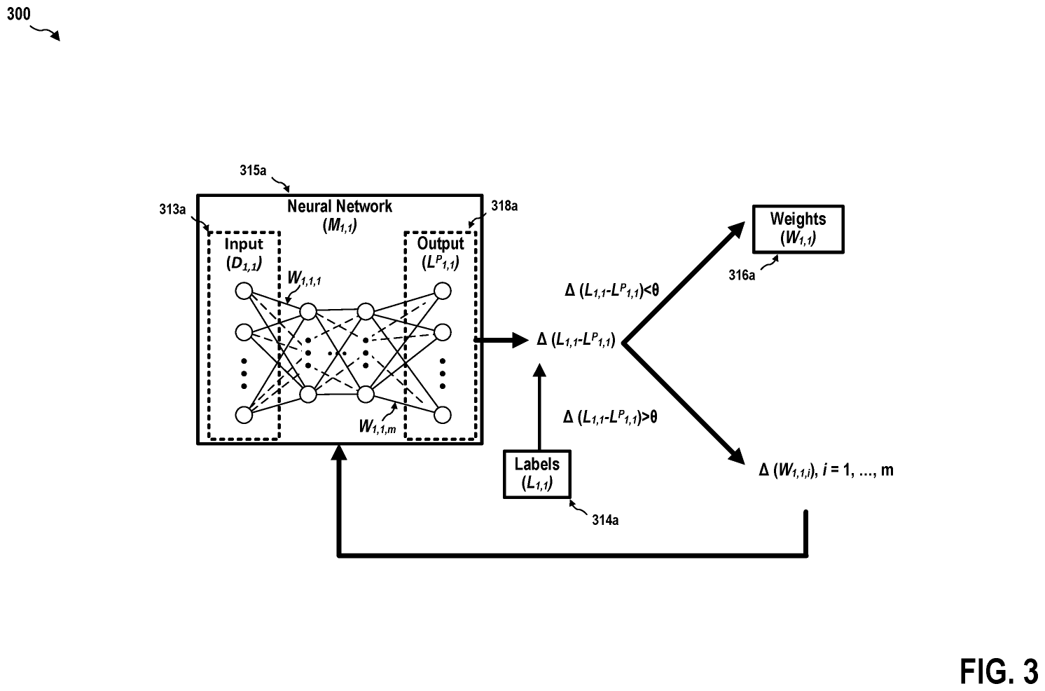

FIG. 3 is a diagram 300 illustrating an example of a generation of a neural network (M_{1,1}) 315a and a related set of weights (W_{1,1}) 316a based on an input dataset (D_{1,1}) 313a and a set of labels (L_{1,1}) 314a. In some aspects, the input dataset (D_{1,1}) 313a and the set of labels (L_{1,1}) 314a includes a plurality (e.g., 10-10,000) of pairs of corresponding input data (e.g., a set of datapoints) and label that may be used to train the weights of the neural network (M_{1,1}) 315a. For example, a neural network may comprise a set of input nodes that correspond to the input data in each set of datapoints of the dataset (D_{1,1}) 313a, a set of internal nodes (a set nodes in one or more internal layers), and a set of output nodes that produce a set of predicted labels (L^{P}_{1,1}) 318a. Each connection between nodes in adjacent layers may be assigned a weight (e.g., W_{1,1,i}, where i=1, . . . , m). The individual weights W_{1,1,i} may initially be a first value and the initial set of values may be used to generate a first set of predicted labels (L^{P}_{1,1}) 318a based on the dataset (D_{1,1}) 313a. The predicted labels (L^{P}_{1,1}) 318a may then be compared to the (user-)assigned labels (L_{1,1}) 314a (e.g., Δ(L_{1,1}-L^{P}_{1,1}) may be calculated) to generate a set of adjustments to the weights (e.g., Δ(W_{1,1,i}), i=1, m). The generated set of adjustments may then be fed back to the neural network to generate a new set of predicted labels (L^{P}_{1,1}) 318a to repeat the process until a difference between the assigned labels (L_{1,1}) 314a and the predicted labels (L^{P}_{1,1}) 318a is less than a threshold value (e.g., Δ(L_{1,1}−L^{P}_{1,1})>0). Once the difference between the assigned labels (L_{1,1}) 314a and the predicted labels (L^{P}_{1,1}) 318a is less than the threshold value, a current set of weights may be used (or may be determined to be) the set of weights (W_{1,1}) 316a associated with neural network (M_{1,1}) 315a.

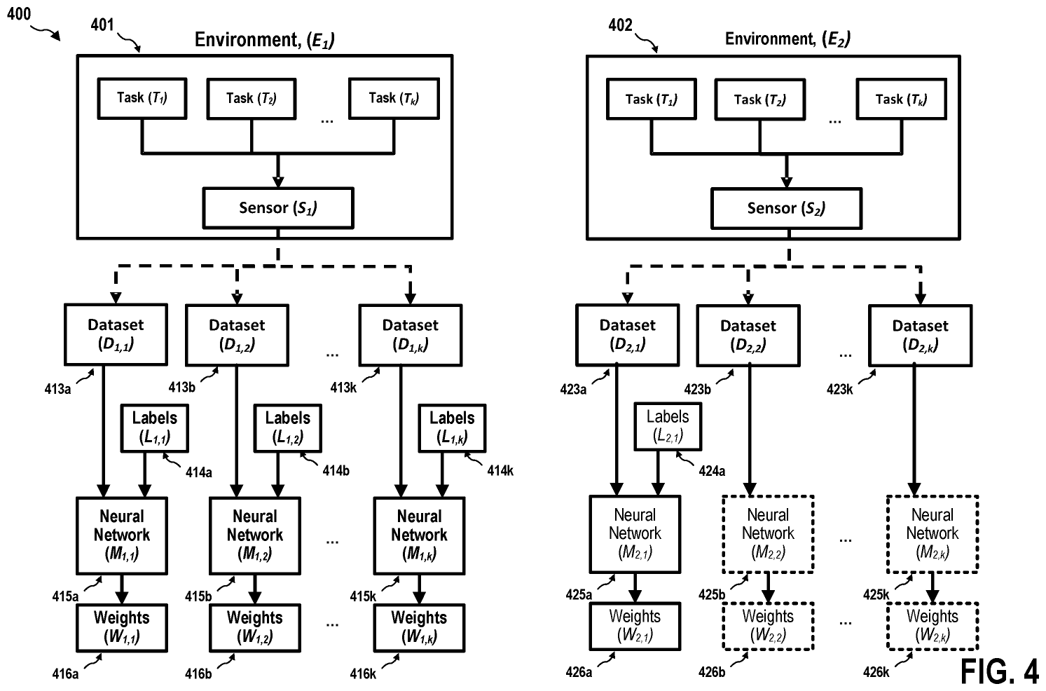

FIG. 4 is a diagram 400 illustrates a set of two environments 401 and 402 for which the method may be applied. Diagram 400 illustrates that datasets 413a, 413b, through 413k in the first environment 401 may be labeled with labels 414a, 414b, through 414k. The datasets 413a, 413b, through 413k and the labels 414a, 414b, through 414k may be used to generate a set of weights 416a, 416b, through 416k for the neural networks 415a, 415b, through 415k. Additionally, diagram 400 illustrates that dataset 423a in the second environment 402 may be labeled with labels 424a. The datasets 423a and the labels 424a may be used to generate a set of weights 426a for the neural network 425a as described above in relation to FIG. 3. The neural networks 425b through 425k and the associated weights 426b through 426k may be generated without going through the process of labeling the datasets 423b through 423k as will be described below.

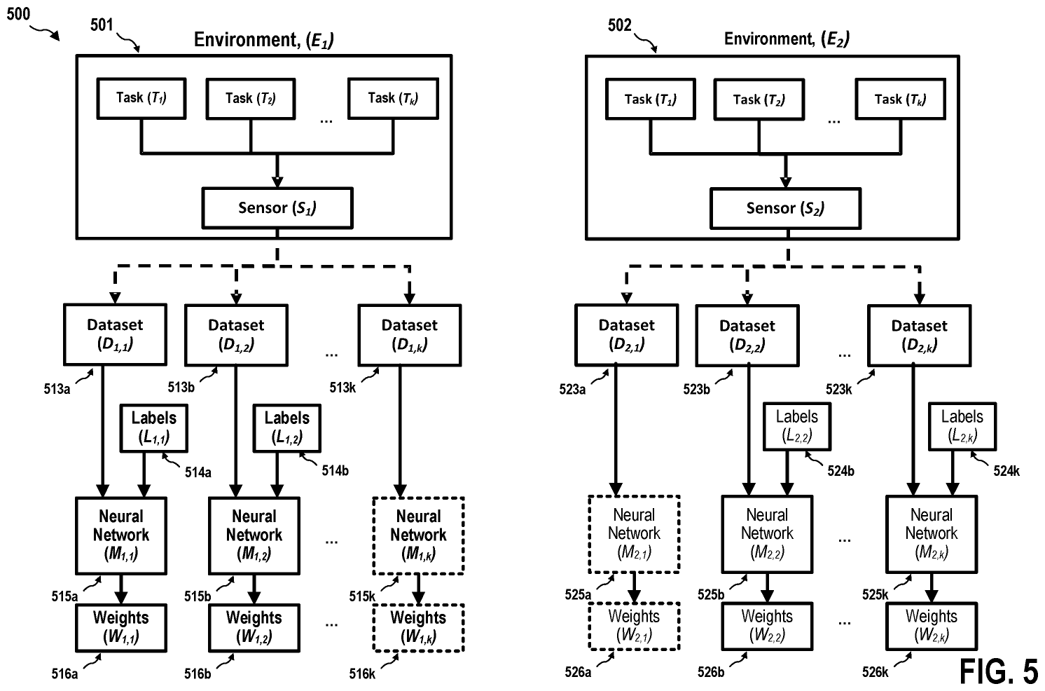

FIG. 5 is a diagram 500 illustrates a set of two environments 501 and 502 for which the method may be applied. Diagram 500 illustrates that datasets 513a and 513b in the first environment 501 may be labeled with labels 514a and 514b. The datasets 513a and 513b and the labels 514a and 514b may be used to generate a set of weights 516a and 516b for the neural networks 515a and 515b. Additionally, diagram 500 illustrates that datasets 523b and 523k in the second environment 502 may be labeled with labels 524b and 524k. The datasets 523b and 523k and the labels 524b and 524k may be used to generate a set of weights 526b and 526k for the neural networks 525b and 525k. The neural networks 515k and 525a and the associated weights 516k and 526a may be generated without going through the process of labeling the datasets 513k and 523a as will be described below. Additional weights for additional tasks may be generated by generating a set of weights in one of the environments and then converting that set of weights into a corresponding set of weights in the other environment.

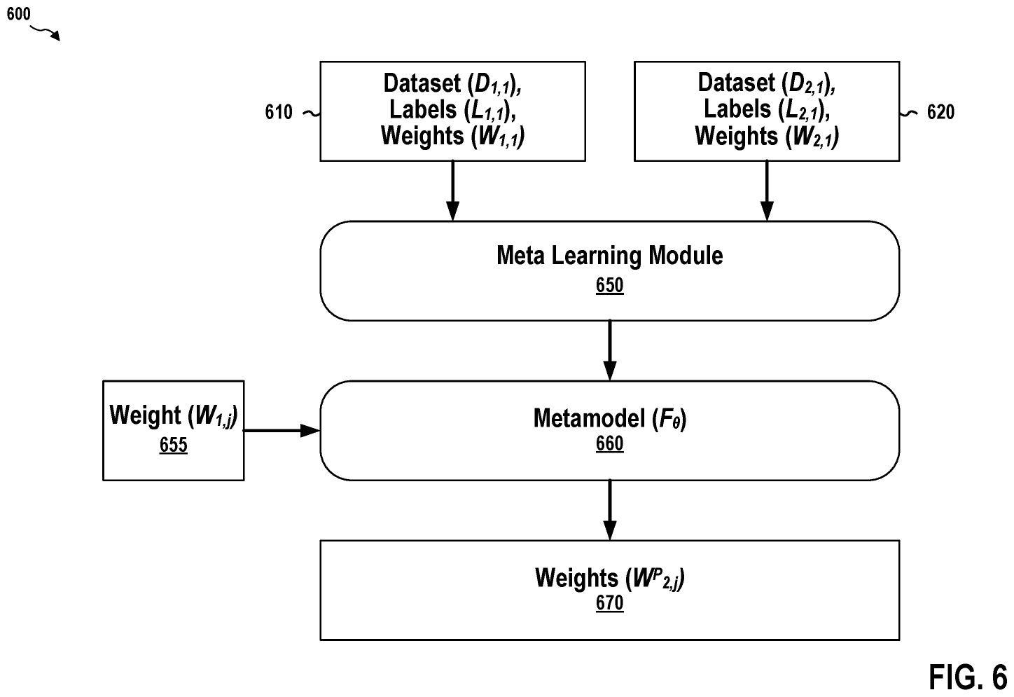

For example, the overlapping datasets 513b and 523b (e.g., datasets for a same task in the different environments) may be used to generate a transformation between their respective weights 516b and 526b. The transformation may be a metamodel neural network that may be trained based on the overlapping datasets 513b and 523b and the corresponding weights 516b and 526b. The training of the metamodel is discussed below in reference to FIGS. 6-8. The metamodel may then be used to generate weight 516k (and corresponding neural network 515k) based on the weight 526k. The metamodel may also be used to generate weight 526a (and corresponding neural network 525a) based on the weight 516a. For other tasks that have weights generated in one environment but not in another environment, the metamodel may be used to transform weights from the one environment to weighs for the other environment. While the example above discusses a set of two environments, the metamodel may be trained to transform weights among any number of environments in which the same task is performed.

In some aspects, the weights (W_{i,j}) are stored as vectors in [symbol] ^{m}, where m is equal to a number of parameters (e.g., a number of trainable parameters, or weights) associated with the neural networks (M_{i,j}). The method is then trained to learn a transformation F_{θ}: [symbol] ^{m}→ [symbol] ^{m} that can map a set of weights from the first environment 501 to a second environment 502. The process to achieve this transformation is by using meta learning which refers to the machine learning algorithm that learns from the output of the other machine learning algorithm.

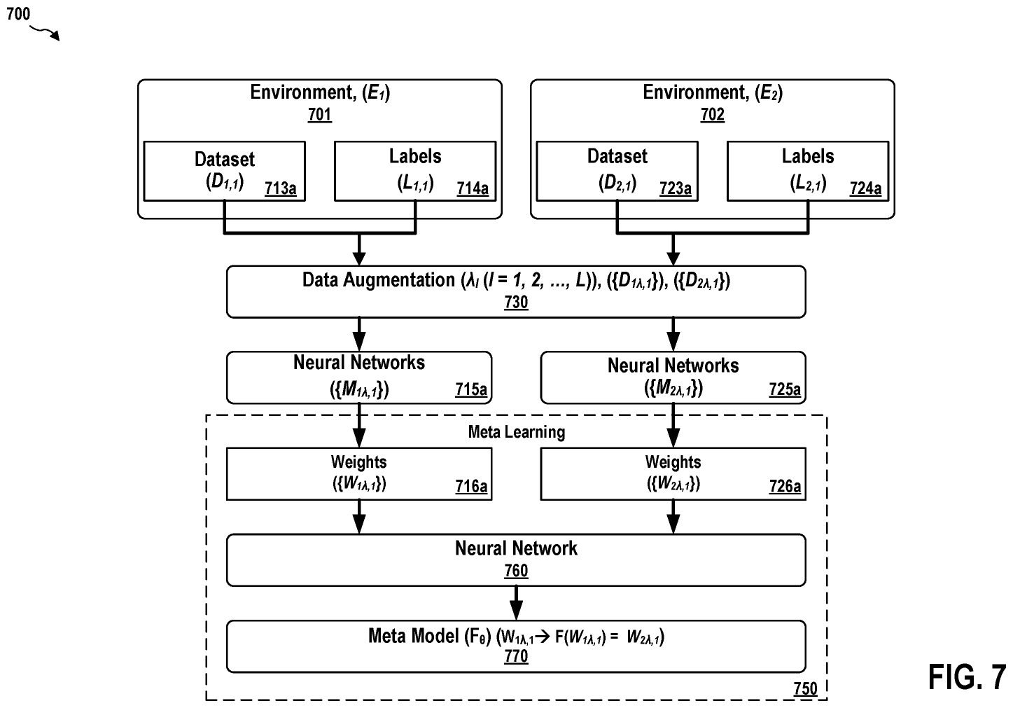

FIG. 6 is a diagram 600 of an overview of the process of using a meta learning based model to generate a set of weights for unlabeled datasets in a second environment from a set of labeled datasets (and associated weights) in a first environment. The process of the meta learning module, in some aspects, may begin with inputs 610 and 620 from first and second environments (e.g., environments 201/301 and 202/302 respectively) for at least one task. The inputs may be provided to a meta learning module 650. The meta model 650 may generate a metamodel (F_{θ}) 660 for transforming weights generated for a task in a first environment into a set of weights for the same task in the other environment as described below in relation to FIG. 7. The metamodel (F_{θ}) 660 may receive a set of weights 655 associated with an additional task in one environment (e.g., a set of weights W_{1,j} for a task ‘j’ in the first environment) and generate a predicted set of weights 670 for the same task in the other environment (e.g., a predicted set of weights W^{P}_{2,j} for the task ‘j’ in the second environment).

FIG. 7 is a diagram 700 illustrating the metamodel generation in accordance with some aspects of the disclosure. Datasets 713a and labels 714a from the first environment 701 and the datasets 723a and labels 724a from the second environment 702 may be provided to a data augmentation module 730. The data augmentation module 730 may generate a number, L, of modified datasets by applying a corresponding number of transformation operations λₗ (for l=1, . . . , L) (e.g., for image data applying one or more of a dilation, a reflection, a rotation, a shear (or skew), and/or a translation). Each of the modified datasets in a set {(D_{1λ,1})} or {(D_{2λ,1})} may be used to train a corresponding neural network {(M_{1λ,1})} 715a or {(M_{2λ,1})} 725a to produce weights {(W_{1λ,1})} 716a or {(W_{2λ,1})} 726a, respectively. The generated weights for a corresponding transformation λₗ may then be used in a meta learning operation 750 to train neural network 760 to transform a set of weights from one environment to a set of weights for another environment. The trained neural network 760 will produce a metamodel (F_{θ}) 770 that can take a set of weights in the first environment W_{1,1} and transform it into a set of weights W_{2,1} in the second environment (and/or vice versa).

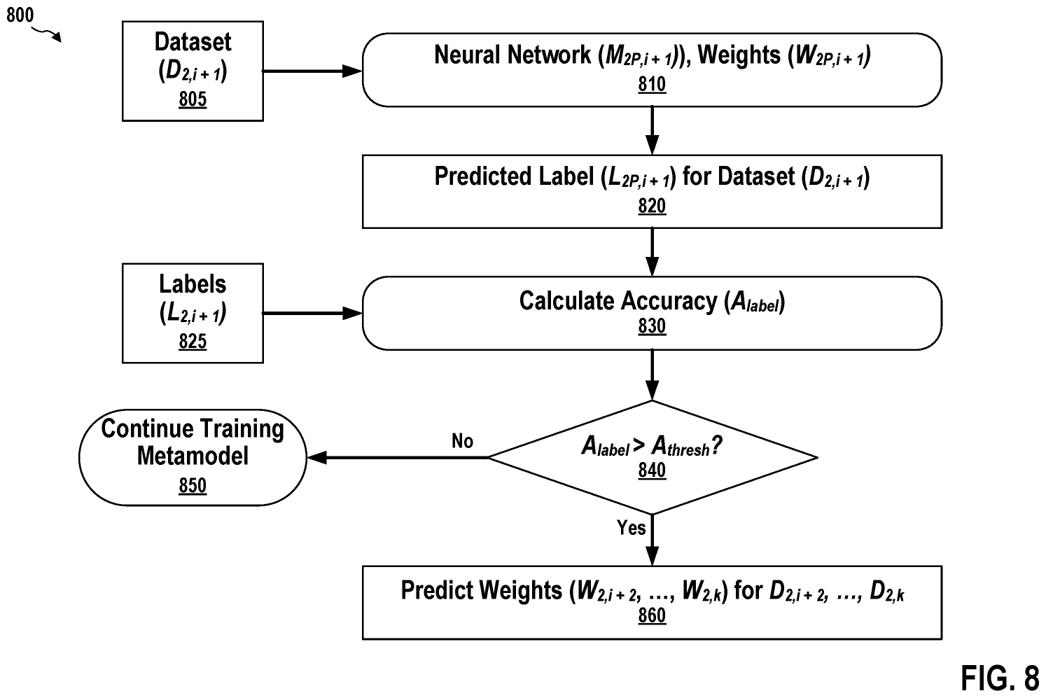

FIG. 8 is a diagram 800 illustrating a feedback process for training the neural network 760. As discussed above in relation to FIG. 6, a metamodel in training (e.g., the metamodel 660) may produce a predicted set of weights 810 (e.g., corresponding, in some aspects, to weights 670) for a second environment based on a set of weights (e.g., 655) for a first environment. A dataset 805 may be processed (input into a neural network) based on the predicted set of weights 810 to produce a predicted label 820 (as discussed in relation to FIG. 3). The predicted label 820 may then be compared to a ‘ground truth’ (e.g., a target or objective label value 825) to calculate, at 830, an accuracy (e.g., A_{Label}) of the predicted label and to determine, at 840, whether an accuracy of the label is greater than a threshold accuracy (e.g., Aₜₕᵣₑₛₕ). If the accuracy is determined to be less than the threshold accuracy the process may continue to train the metamodel at 850 based on the difference between the predicted labels and the ground truth label value 825 similarly to the updating of the weights described in relation to FIG. 3. If the accuracy of the label is determined to be above the threshold accuracy the training ends and the trained metamodel may be used to generate the predicted weights for unlabeled datasets in the second environment based on corresponding (e.g., for a same task) labeled sets from the first environment (or vice versa).

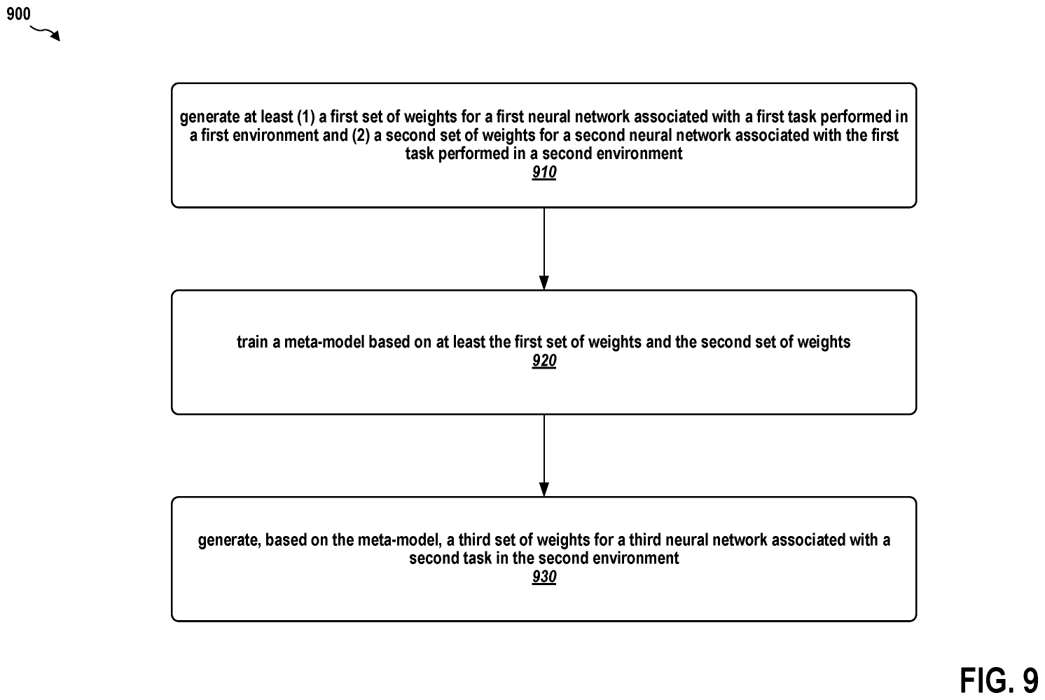

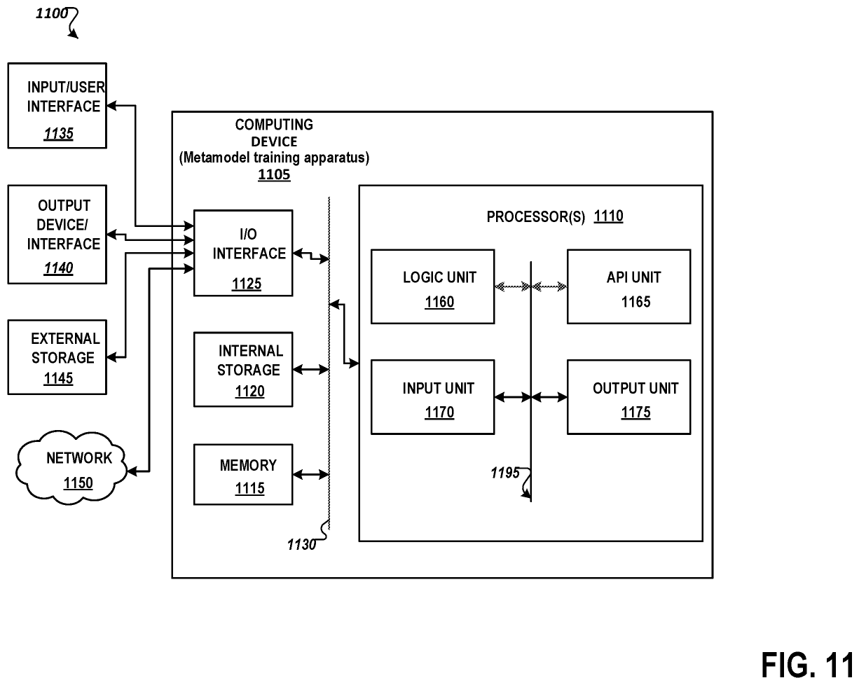

FIG. 9 is a flow diagram 900 illustrating a method in accordance with some aspects of the disclosure. In some aspects, the method is performed by the computing device (metamodel training apparatus) 1105 of FIG. 11 or a distributed computing device (e.g., a distributed set of computing devices) having similar components. At 910, the computing device may generate at least (1) a first set of weights for a first neural network associated with a first task performed in a first environment and (2) a second set of weights for a second neural network associated with the first task performed in a second environment. In some aspects, generating the first set of weights at 910 may be based on data captured by a first set of sensors in the first environment and the first neural network may be for analysis of the data captured by the first set of sensors related to the first task in the first environment. Generating the first set of weights at 910, in some aspects, may further be based on a first set of labels associated with the data captured by the first set of sensors in the first environment. The first set of labels, in some aspects, may be user-generated labels or software-generated labels. For example, referring to FIGS. 2 and 3, the computing device may generate a set of weights 216a to 216k or 316a based on (1) a set of input data from the input datasets (D_{1,1}) 213a to (D_{1,k}) 213k or (D_{1,1}) 313a and (2) a corresponding set of labels (L_{1,1}) 214a to (L_{1,k}) 214k or (L_{1,1}) 314a, respectively as illustrated for the set of weights 316a.

Similarly, in some aspects, generating the second set of weights at 910 may be based on data captured by a second set of sensors in the second environment and the second neural network may be for analysis of the data captured by the second set of sensors related to the first task in the second environment. Generating the second set of weights at 910, in some aspects, may further be based on a second set of labels associated with the data captured by the second set of sensors in the second environment. The second set of labels, in some aspects, may be user-generated labels or software-generated labels. For example, referring to FIGS. 3 and 4, the computing device may generate an additional set of weights 426a from a dataset 423a and labels 424a associated with the second environment 402, similarly to how it generated the weights 316a based on the set of input data from the input dataset (D_{1,1}) 313a and based on the corresponding set of labels (L_{1,1}) 314a.

At 920, the computing device may train a metamodel based on at least the first set of weights and the second set of weights. In some aspects, each set of weights (e.g., the first and second set of weights generated at 910) may be a vector of weight values and training the metamodel may include generating at least a first matrix for converting sets of weights associated with tasks in the first environment to corresponding sets of weights associated with corresponding tasks in the second environment. In some aspects, training the metamodel at 920 may include generating at least a second matrix for converting sets of weights associated with tasks in the second environment to corresponding sets of weights associated with corresponding tasks in the first environment. For example, referring to FIGS. 4-8, the computing device may train a metamodel 660 and/or 770 based on weights 416a and 426a and/or 516b and 526b based on the processes illustrated in diagrams 600, 700, and 800.

At 930, the computing device may generate, based on the metamodel, a third set of weights for a third neural network associated with a second task in the second environment. In some aspects, generating, based on the metamodel, the third set of weights at 930 may be based on data captured by the second set of sensors in the second environment. The third neural network, in some aspects, may be for analysis of the data captured by the second set of sensors related to the second task in the second environment. For example, referring to FIGS. 6-8, the computing device may use a metamodel 660 and/or 770 to generate a set of weights 670 or 860.

In some aspects, generating the third set of weights at 930 may further be based on a fourth set of weights for a fourth neural network associated with a second task in the first environment. For example, generating the third set of weights at 930 may include providing the fourth set of weights as an input to the metamodel. Generating the third set of weights at 930 may further include, based on providing the fourth set of weights as the input to the metamodel, outputting the third set of weights from the metamodel. For example, referring to FIG. 6, the computing device may provide/receive the weights 655 and output a set of weights 670.

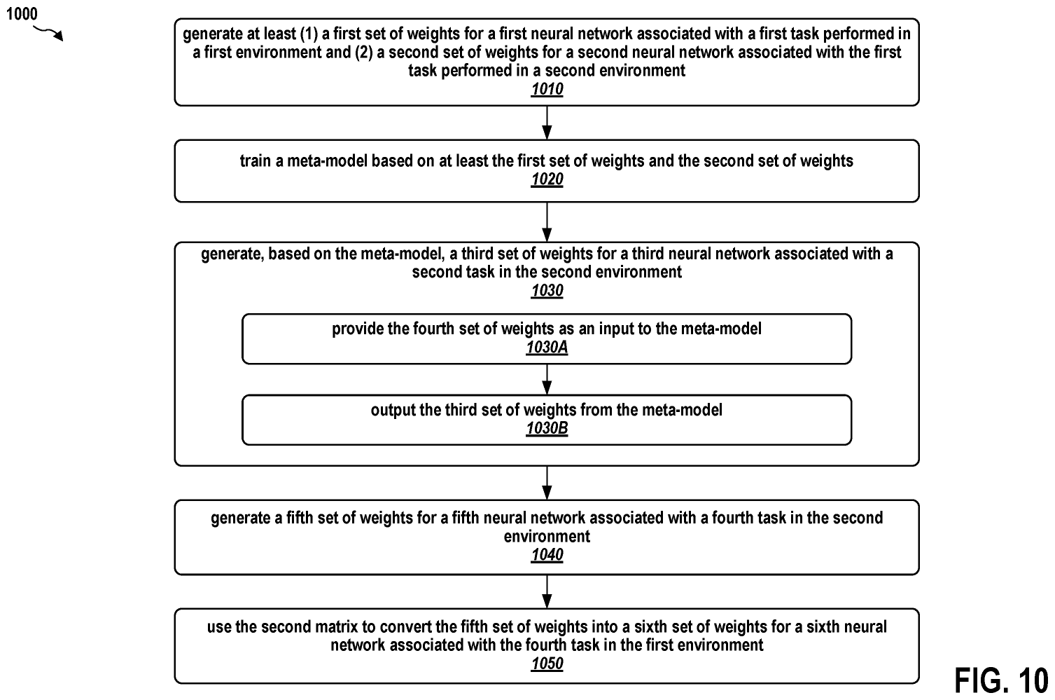

FIG. 10 is a flow diagram 1000 illustrating a method in accordance with some aspects of the disclosure. In some aspects, the method is performed by the computing device (metamodel training apparatus) 1105 of FIG. 11 or a distributed computing device (e.g., a distributed set of computing devices) having similar components. At 1010, the computing device may generate at least (1) a first set of weights for a first neural network associated with a first task performed in a first environment and (2) a second set of weights for a second neural network associated with the first task performed in a second environment. In some aspects, generating the first set of weights at 1010 may be based on data captured by a first set of sensors in the first environment and the first neural network may be for analysis of the data captured by the first set of sensors related to the first task in the first environment. Generating the first set of weights at 1010, in some aspects, may further be based on a first set of labels associated with the data captured by the first set of sensors in the first environment. The first set of labels, in some aspects, may be user-generated labels or software-generated labels. For example, FIGS. 2 and 3, the computing device may generate a set of weights 216a to 216k or 316a based on (1) a set of input data from the input datasets (D_{1,1}) 213a to (D_{1,k}) 213k or (D_{1,1}) 313a and (2) a corresponding set of labels (L_{1,1}) 214a to (L_{1,k}) 214k or (L_{1,1}) 314a, respectively as illustrated for the set of weights 316a.

Similarly, in some aspects, generating the second set of weights at 1010 may be based on data captured by a second set of sensors in the second environment and the second neural network may be for analysis of the data captured by the second set of sensors related to the first task in the second environment. Generating the second set of weights at 1010, in some aspects, may further be based on a second set of labels associated with the data captured by the second set of sensors in the second environment. The second set of labels, in some aspects, may be user-generated labels or software-generated labels. For example, referring to FIGS. 3 and 4, the computing device may generate an additional set of weights 426a from a dataset 423a and labels 424a associated with the second environment 402, similarly to how it generated the weights 316a based on the set of input data from the input dataset (D_{1,1}) 313a and based on the corresponding set of labels (L_{1,1}) 314a.

At 1020, the computing device may train a metamodel based on at least the first set of weights and the second set of weights. In some aspects, each set of weights (e.g., the first and second set of weights generated at 1010) may be a vector of weight values and training the metamodel may include generating at least a first matrix for converting sets of weights associated with tasks in the first environment to corresponding sets of weights associated with corresponding tasks in the second environment. In some aspects, training the metamodel at 1020 may include generating at least a second matrix for converting sets of weights associated with tasks in the second environment to corresponding sets of weights associated with corresponding tasks in the first environment. For example, referring to FIGS. 4-8, the computing device may train a metamodel 660 and/or 770 based on weights 416a and 426a and/or 516b and 526b based on the processes illustrated in diagrams 600, 700, and 800.

At 1030, the computing device may generate, based on the metamodel, a third set of weights for a third neural network associated with a second task in the second environment. In some aspects, generating, based on the metamodel, the third set of weights at 1030 may be based on data captured by the second set of sensors in the second environment. The third neural network, in some aspects, may be for analysis of the data captured by the second set of sensors related to the second task in the second environment. For example, referring to FIGS. 6-8, the computing device may use a metamodel 660 and/or 770 to generate a set of weights 670 or 860.

In some aspects, generating the third set of weights at 1030 may further be based on a fourth set of weights for a fourth neural network associated with a second task in the first environment. For example, generating the third set of weights at 1030 may include, at 1030A, providing the fourth set of weights as an input to the metamodel. Generating the third set of weights at 1030 may further include, based on providing the fourth set of weights as the input to the metamodel at 1030A, outputting, at 1030B, the third set of weights from the metamodel. For example, referring to FIG. 6, the computing device may provide/receive the weights 655 and output a set of weights 670.

At 1040, the computing device may, in some aspects, generate a fifth set of weights for a fifth neural network associated with a fourth task in the second environment. Generating the fifth set of weights at 1040, in some aspects, may be based on data captured by a second set of sensors in the second environment and the fifth neural network may be for analysis of the data captured by the second set of sensors related to the fourth task in the second environment. Generating the fifth set of weights at 1040, in some aspects, may further be based on a third set of labels associated with the data captured by the second set of sensors in the second environment. The third set of labels, in some aspects, may be user-generated labels or software-generated labels. For example, referring to FIGS. 3 and 5, the computing device may generate a set of weights 526k for an additional task (e.g., task “k”) in the second environment 502 based on the dataset 523k and labels 524k based on the process illustrated in FIG. 3.

At 1050, the computing device may use the second matrix generated at 1020 to convert the fifth set of weights into a sixth set of weights for a sixth neural network associated with the fourth task in the first environment. In some aspects, generating, based on the metamodel, the sixth set of weights at 1050 may be based on data captured by the first set of sensors in the first environment. The sixth neural network, in some aspects, may be for analysis of the data captured by the first set of sensors related to the fourth task in the second environment. For example, referring to FIGS. 6-8, the computing device may use a metamodel 660 and/or 770 to generate a set of weights 670 or 860.

For example, generating the sixth set of weights at 1050 may include providing the fifth set of weights as an input to the metamodel. Generating the sixth set of weights at 1050 may further include, based on providing the fifth set of weights as the input to the metamodel, outputting the sixth set of weights from the metamodel. For example, referring to FIG. 6, the computing device may provide/receive the weights 655 and output a set of weights 670.

In accordance with some aspects of the disclosure, a method and apparatus for generating a neural network (e.g., weights for the neural network) for an analysis of a task is provided. The method and apparatus may generate the neural network based on weights for a corresponding (e.g., a parallel) task in a different environment based on a metamodel generated for performing a conversion and/or transformation from weights in the first environment to weights in the second environment. For example, the method and/or apparatus may be used to replace custom-developed analytics solutions for each task (e.g., a production line or process) in each environment. For example, in factories, analytics solutions are usually custom developed for one line/product and much system integration is needed to scale the solution onto another line due to a change in sensor deployments such as lighting, camera placement, line condition, or other changes. This custom development may increase the deployment cost and time. The method and apparatus presented may allow an analytics solution developed for K number of tasks for one line/environment can be applied for the same tasks in an additional line/environment. This process of using the meta model described above may minimize manual labeling process for a new line/environment which in turn helps in reducing the deployment cost and time.

FIG. 11 illustrates an example computing environment with an example computer device suitable for use in some example implementations. Computer device 1105 in computing environment 1100 can include one or more processing units, cores, or processors 1110, memory 1115 (e.g., RAM, ROM, and/or the like), internal storage 1120 (e.g., magnetic, optical, solid-state storage, and/or organic), and/or IO interface 1125, any of which can be coupled on a communication mechanism or bus 1130 for communicating information or embedded in the computer device 1105. IO interface 1125 is also configured to receive images from cameras or provide images to projectors or displays, depending on the desired implementation.

Computer device 1105 can be communicatively coupled to input/user interface 1135 and output device/interface 1140. Either one or both of the input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via IO interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

IO interface 1125 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blue-ray disks), solid-state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, the input unit 1170, the output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide an output based on the calculations described in example implementations.

Processor(s) 1110 can be configured to obtain material properties and modal properties of the physical system. The processor(s) 1110 can be configured to measure, via one or more sensors, a response of the physical system. The processor(s) 1110 can be configured to obtain first quantities based on the modal properties and a material-property matrix derived from the material properties. The processor(s) 1110 can be configured to calculate a first intermediate matrix from the modal properties and the response. The processor(s) 1110 can be configured to recursively compute, for each time step during measurement of the response, a second intermediate matrix based on (1) the first quantities, (2) the first intermediate matrix, and (3) a previously computed second intermediate matrix from at least one previous time step. The processor(s) 1110 can be configured to calculate the force and the moment for each time step during the measurement of the response based on the second intermediate matrix and the modal properties.

The processor(s) 1110 can also be configured to multiply the first intermediate matrix by the obtained first quantities, divide a result of the multiplication by a time-step size; and subtract a value based on a previously computed second intermediate matrix from at least one previous time step. The processor(s) 1110 can also be configured to pre-multiply at least one second intermediate matrix for each time step by an inverse of a transpose of a modal property matrix, the modal property matrix including (i) a first set of mode shape vectors and (ii) a second set of products of mode shape vectors and natural frequencies.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method comprising:
generating at least (1) a first set of weights for a first neural network associated with a first task performed in a first environment and (2) a second set of weights for a second neural network associated with the first task performed in a second environment;
training a metamodel based on at least the first set of weights and the second set of weights; and
generating, based on the metamodel, a third set of weights for a third neural network associated with a second task in the second environment.

2. The method of claim 1, wherein:
generating the first set of weights is based on data captured by a first set of sensors in the first environment,
generating the second set of weights is based on data captured by a second set of sensors in the second environment, and
generating, based on the metamodel, the third set of weights is based on data captured by the second set of sensors in the second environment.

3. The method of claim 2, wherein:
the first neural network is for analysis of the data captured by the first set of sensors related to the first task in the first environment,
the second neural network is for analysis of the data captured by the second set of sensors related to the first task in the second environment, and
the third neural network is for analysis of the data captured by the second set of sensors related to the second task in the second environment.

4. The method of claim 2, wherein:
generating the first set of weights is further based on a first set of labels associated with the data captured by the first set of sensors in the first environment, and
generating the second set of weights is further based on a second set of labels associated with the data captured by the second set of sensors in the second environment.

5. The method of claim 1, wherein generating the third set of weights is further based on a fourth set of weights for a fourth neural network associated with a second task in the first environment.

6. The method of claim 5, wherein generating the third set of weights comprises:
providing the fourth set of weights as an input to the metamodel; and
outputting the third set of weights from the metamodel.

7. The method of claim 5, wherein each set of weights comprises a vector of weight values and training the metamodel comprises generating at least a first matrix for converting sets of weights associated with different tasks in the first environment to corresponding sets of weights associated with the different tasks in the second environment, and generating the third set of weights comprises using the first matrix to convert the fourth set of weights into the third set of weights.

8. The method of claim 7, wherein training the metamodel comprises generating at least a second matrix for converting sets of weights associated with different tasks in the second environment to corresponding sets of weights associated with the different tasks in the first environment, the method further comprising:
generating a fifth set of weights for a fifth neural network associated with a fourth task in the second environment; and
using the second matrix to convert the fifth set of weights into a sixth set of weights for a sixth neural network associated with the fourth task in the first environment.

9. A system comprising:
a memory; and
a set of processors coupled to the memory, the set of processors configured to:
generate at least (1) a first set of weights for a first neural network associated with a first task performed in a first environment and (2) a second set of weights for a second neural network associated with the first task performed in a second environment;
train a metamodel based on at least the first set of weights and the second set of weights; and
generate, based on the metamodel, a third set of weights for a third neural network associated with a second task in the second environment.

10. The system of claim 9, wherein:
the set of processors is configured to generate the first set of weights based on data captured by a first set of sensors in the first environment,
the set of processors is configured to generate the second set of weights based on data captured by a second set of sensors in the second environment, and
the set of processors is configured to generate, based on the metamodel, the third set of weights based on data captured by the second set of sensors in the second environment.

11. The system of claim 10, wherein:
the first neural network is for analysis of the data captured by the first set of sensors related to the first task in the first environment,
the second neural network is for analysis of the data captured by the second set of sensors related to the first task in the second environment, and
the third neural network is for analysis of the data captured by the second set of sensors related to the second task in the second environment.

12. The system of claim 10, wherein:
the set of processors is configured to generate the first set of weights based on a first set of labels associated with the data captured by the first set of sensors in the first environment, and
the set of processors is configured to generate the second set of weights based on a second set of labels associated with the data captured by the second set of sensors in the second environment.

13. The system of claim 9, wherein the set of processors configured to generate the third set of weights is further configured to:
provide a fourth set of weights for a fourth neural network associated with a second task in the first environment as an input to the metamodel; and
output the third set of weights from the metamodel.

14. The system of claim 13, wherein each set of weights comprises a vector of weight values and training the metamodel comprises generating at least a first matrix for converting sets of weights associated with different tasks in the first environment to corresponding sets of weights associated with the different tasks in the second environment, and generating the third set of weights comprises using the first matrix to convert the fourth set of weights into the third set of weights.

15. A non-transitory machine readable medium storing sets of instructions that, when executed by a set of processors, causes the set of processors to:
generate at least (1) a first set of weights for a first neural network associated with a first task performed in a first environment and (2) a second set of weights for a second neural network associated with the first task performed in a second environment;
train a metamodel based on at least the first set of weights and the second set of weights; and
generate, based on the metamodel, a third set of weights for a third neural network associated with a second task in the second environment.

16. The non-transitory machine readable medium of claim 15, wherein:
the sets of instructions further causes the set of processors to generate the first set of weights based on data captured by a first set of sensors in the first environment,
the sets of instructions further causes the set of processors to generate the second set of weights based on data captured by a second set of sensors in the second environment, and
the sets of instructions further causes the set of processors to generate, based on the metamodel, the third set of weights based on data captured by the second set of sensors in the second environment.

17. The non-transitory machine readable medium of claim 16, wherein:
the first neural network is for analysis of the data captured by the first set of sensors related to the first task in the first environment,
the second neural network is for analysis of the data captured by the second set of sensors related to the first task in the second environment, and
the third neural network is for analysis of the data captured by the second set of sensors related to the second task in the second environment.

18. The non-transitory machine readable medium of claim 16, wherein:
the sets of instructions further causes the set of processors to generate the first set of weights based on a first set of labels associated with the data captured by the first set of sensors in the first environment, and
the sets of instructions further causes the set of processors to generate the second set of weights based on a second set of labels associated with the data captured by the second set of sensors in the second environment.

19. The non-transitory machine readable medium of claim 15, wherein the sets of instructions causing the set of processors to generate the third set of weights further causes the set of processors to:
provide a fourth set of weights for a fourth neural network associated with a second task in the first environment as an input to the metamodel; and
output the third set of weights from the metamodel.

20. The non-transitory machine readable medium of claim 19, wherein each set of weights comprises a vector of weight values and training the metamodel comprises generating at least a first matrix for converting sets of weights associated with different tasks in the first environment to corresponding sets of weights associated with the different tasks in the second environment, and generating the third set of weights comprises using the first matrix to convert the fourth set of weights into the third set of weights.
